(19) United States
(12) Patent Application Publication
(10) Pub. No.: US 2026/0364797 A1
(43) Pub. Date: Nov. 19, 2026

(54) CONTROL DEVICE, TRAJECTORY GENERATION METHOD, AND RECORDING MEDIUM

(71) Applicant: NEC Corporation, Tokyo (JP)

(72) Inventors: Hiroyuki OYAMA, Tokyo (JP); Rin TAKANO, Tokyo (JP); Kei TAKAYA, Tokyo (JP)

(73) Assignee: NEC Corporation, Tokyo (JP)

(21) Appl. No.: 19/515,873

(22) PCT Filed: Sep. 14, 2023
(86) PCT No.: PCT/JP2023/033545

§ 371 Date: Mar. 3, 2026

(51) Int. Cl. B25J 9/16

(52) U.S. Cl. CPC B25J 9/1666; B25J 9/163

(57) ABSTRACT

A control device that includes a target trajectory candidate generation unit that generates at least one target trajectory candidate using a trajectory generation model that generates a target trajectory, and a target trajectory correction unit that corrects the target trajectory candidate and generates a target trajectory satisfying a constraint condition.

### TECHNICAL FIELD

The present disclosure relates to a control device, a trajectory generation method, and a recording medium.

### BACKGROUND ART

In recent years, robots have been introduced in various scenes, and automation of work by robots has been performed. Accordingly, it is required to generate an operation plan of a robot having a high success rate. For example, PTL 1 discloses a technique for calculating a trajectory that allows a robot to avoid an obstacle based on a generation model. Although various methods for calculating the trajectory of the robot have been proposed, a trajectory with low feasibility may be calculated.

### CITATION LIST

### Patent Literature

PTL 1: JP 2020-196102 A

### SUMMARY OF INVENTION

### Technical Problem

An object of the present disclosure is to provide a technique for calculating a trajectory having high feasibility.

The present disclosure provides a control device, a trajectory generation method, and a recording medium that can solve the above problems.

### Solution to Problem

According to an aspect of the present disclosure, a control device includes a target trajectory candidate generation means for generating at least one target trajectory candidate using a trajectory generation model that generates a target trajectory, and a target trajectory correction means for correcting the target trajectory candidate and generating a target trajectory satisfying a constraint condition.

According to an aspect of the present disclosure, a trajectory generation method includes generating at least one target trajectory candidate by using a trajectory generation model that generates a target trajectory, and correcting the target trajectory candidate to calculate a target trajectory satisfying a constraint condition.

According to an aspect of the present disclosure, a recording medium is a recording medium storing a program for causing a computer to execute a step of generating at least one target trajectory candidate by using a trajectory generation model that generates a target trajectory, and a step of correcting the target trajectory candidate to calculate a target trajectory satisfying a constraint condition.

### Advantageous Effects of Invention

According to the control device, the trajectory generation method, and the recording medium described above, it is possible to calculate a trajectory having high feasibility.

### BRIEF DESCRIPTION OF DRAWINGS

FIG. 1 is a first diagram illustrating an example of a control device.

FIG. 2 is a diagram illustrating an example of an evaluation function.

FIG. 3 is a diagram illustrating an example of a trajectory.

FIG. 4 is a diagram for describing generation of a target trajectory candidate by a trajectory generation model.

FIG. 5 is a first flowchart illustrating an example of a target trajectory generation process.

FIG. 6 is a second diagram illustrating an example of a control device.

FIG. 7 is a second flowchart illustrating an example of a target trajectory generation process.

FIG. 8 is a third diagram illustrating an example of a control device.

FIG. 9 is a first diagram for describing generation of a low dimensional trajectory generation model and a target trajectory candidate by the trajectory generation model.

FIG. 10 is a second diagram for describing generation of a low dimensional trajectory generation model and a target trajectory candidate by the trajectory generation model.

FIG. 11 is a third flowchart illustrating an example of a target trajectory generation process.

FIG. 12 is a first diagram illustrating an application example of at least one example embodiment.

FIG. 13 is a second diagram illustrating an application example of at least one example embodiment.

FIG. 14 is a diagram illustrating an example of a two dimensional model.

FIG. 15 is a block diagram illustrating a configuration of a control device having a minimum configuration.

FIG. 16 is a flowchart of a trajectory generation method having a minimum configuration.

### EXAMPLE EMBODIMENT

### First Example Embodiment

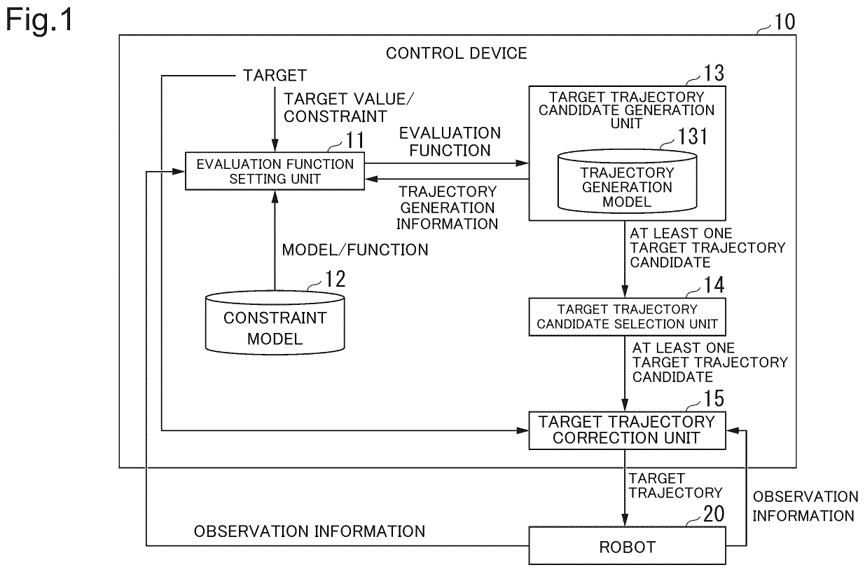

Hereinafter, a control device according to a first example embodiment will be described with reference to FIGS. 1 to 5.

### (Configuration)

FIG. 1 is a first diagram illustrating an example of a control device. A control device 10 controls a robot 20. FIG. 1 illustrates a function of generating a trajectory of the robot 20 among various functions related to control of the robot 20 included in the control device 10. The trajectory of the robot 20 is a trajectory when the robot 20 moves, that is, a trajectory of a distal end of an arm when the robot 20 performs various works using the arm, and the like. The control device 10 calculates a trajectory having high feasibility while satisfying various constraints such as obstacle avoidance.

The control device 10 includes an evaluation function setting unit 11, a constraint model 12, a target trajectory candidate generation unit 13, a target trajectory candidate selection unit 14, and a target trajectory correction unit 15.

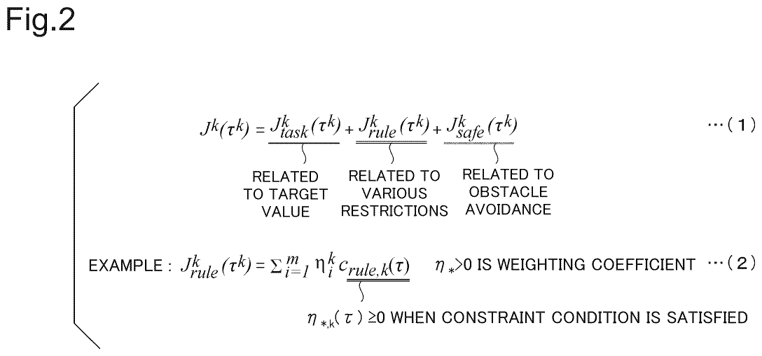

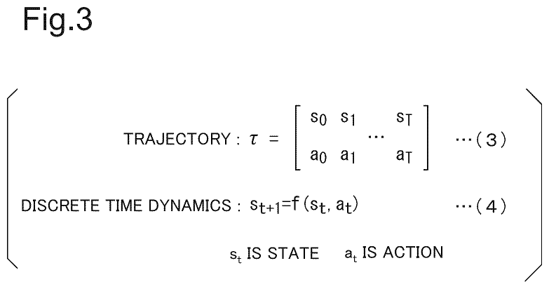

The evaluation function setting unit 11 acquires a target value, a constraint condition, observation information measured by the robot 20, and the like, and sets an evaluation function of evaluating the trajectory generated by the target trajectory candidate generation unit 13. The target value includes, for example, a target position, a speed, an acceleration, a posture, part of a trajectory (for example, the trajectory that is required to be passed before reaching the target position), a target task order, a formal language such as time-phase logic, a reward, and the like. The constraint condition includes, for example, a restriction such as a position, a speed, and an acceleration, a rule of an operation, and a constraint by formulation. The observation information includes initial environment information, obstacle information, information about an object to be worked, and the like. An example of the evaluation function is shown in Expression (1) of FIG. 2. For example, the evaluation function J^{k}(τ^{k}) can be expressed as a weighted sum in which a weighting coefficient is set to each of a function indicating the degree of achievement of the target value, a function indicating how much various constraints are satisfied, and a function indicating the degree of achievement of obstacle avoidance. Expression (1) is configured in such a way that the value of the evaluation function J^{k}(τ^{k}) increases as the target value is achieved more, the constraint condition is satisfied more, and the collision with the obstacle is avoided more. An example of the functions c_{rule,k}(τ) and the weighting coefficient η indicating how much various constraints are satisfied is illustrated in Expression (2) of FIG. 2. τ^{k} indicates a trajectory τ calculated at the k-th step (described later). τ represents the trajectory of the robot 20 and can be expressed by Expression (3) in FIG. 3. s constituting τ represents the state of the robot 20, and a represents the action of the robot 20. The relationship between s and a can be expressed by Expression (4) in FIG. 3. The subscript t in Expression (4) represents time. The state s may include an operation mode of the robot 20.

The constraint model 12 is, for example, a constraint model such as a success/failure discriminator. The success/failure discriminator is a trained model, a neural network, or the like that predicts whether a trajectory generated by the target trajectory candidate generation unit 13 is successful or failed when the trajectory is input. For example, when a trajectory is input to the success/failure discriminator, the success/failure discriminator calculates a success score representing the degree of success of the input trajectory. The success/failure discriminator determines success when the calculated success score is equal to or greater than a preset threshold value, and determines failure when the success score is less than the threshold value. For example, the success/failure discriminator can be applied to the second term on the right side of Expression (1) in FIG. 2.

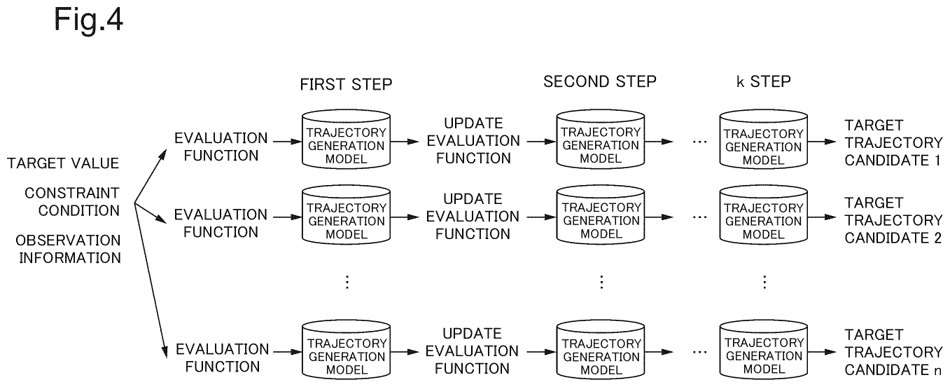

The target trajectory candidate generation unit 13 includes a trajectory generation model 131 that is a generation model for calculating the trajectory of the robot 20. For example, the trajectory generation model 131 may be a diffusion model (Denoising Diffusion Probabilistic Models: DDPM) among the generation models. The diffusion model is a generation model obtained by learning a diffusion process of adding noise to data and converting the data into noise and a reverse diffusion process of tracing the diffusion process in opposite directions. A method of using the diffusion model to generate the trajectory is disclosed in, for example, “Janner, Michael, et al. “Planning with diffusion for flexible behavior synthesis.” arXiv preprint arXiv:2205.09991 (2022).”, and this method can also be applied to the construction of the trajectory generation model 131 of the present disclosure. The target trajectory candidate generation unit 13 constructs the trajectory generation model 131 that is a diffusion model by DDPM. The target trajectory candidate generation unit 13 sets the evaluation function J(τ), the Gaussian noise, and the like set by the evaluation function setting unit 11 based on the target value and the constraint condition, and generates the trajectory of the robot 20 having the maximum evaluation function J(τ), for example, using the trajectory generation model 131. With reference to FIG. 4, an outline of a trajectory generation process using the trajectory generation model 131 (diffusion model) will be described.

The target trajectory candidate generation unit 13 generates a trajectory using the trajectory generation model 131 (first step). For example, the target trajectory candidate generation unit 13 generates a trajectory using the trajectory generation model 131 a plurality of times (for example, n times). Even when the trajectory is generated by setting the same constraint condition or the like, the trajectory generated by the diffusion model is often different every time. n trajectories are generated by performing the generation of the trajectories n times. The first-step (first time) trajectory generated by the diffusion model is often generated to be greatly different from the target trajectory, and the trajectory is gradually closer to the target value every time the number of times is increased while the constraint condition is adjusted, and the trajectory more strictly satisfying the constraint condition is generated. Therefore, the target trajectory candidate generation unit 13 performs trajectory generation of the second to K-th steps using the trajectory generation model 131 for each of the n target trajectory candidates. Through such a process, various target trajectory candidates 1 to n (when the good value of the evaluation function is obtained, it is considered that the value is close to the target value, satisfies the constraint condition well, and is not likely to collide with an obstacle) that have good evaluation function values are obtained. At this time, the target trajectory candidate generation unit 13 adjusts the evaluation function in the process of repeating the processing from the first to K-th steps in such a way as to obtain a target trajectory candidate that is closer to the target value, more strictly satisfies the constraint conditions, and does not collide with an obstacle. For example, the target trajectory candidate generation unit 13 may gradually change the evaluation function to a strict one in the process of repeating the processing from the first to K-th steps. For example, the target trajectory candidate generation unit 13 may adjust the evaluation function in such a way that the constraint condition becomes strict as the number of steps increases according to the following Expression (5).

cᵣᵤₗₑ^{k}(τ)+γ(K−k)≥0, γ>0, 1≤k≤K (5)

For example, when the target trajectory candidates 1 to n obtained so far after execution of several steps deviate greatly from the constraint condition, the target trajectory candidate generation unit 13 may increase the weighting η of J^{k}ᵣᵤₗₑ(τ^{k}) in Expression (1) of FIG. 2, and may prompt generation of a trajectory candidate focusing on achievement of the constraint condition. Thereafter, in a case where many trajectory candidates that have been improved with respect to the constraint condition but deviate from the target value are generated, for example, the target trajectory candidate generation unit 13 may increase the weighting of J^{k}ₜₐₛₖ(τ^{k}) in Expression (1) of FIG. 2 to urge the generation of the trajectory candidates focusing on the achievement of the target value. The adjustment of the evaluation function may be performed every step or may be performed once in several steps. The evaluation function may be adjusted by different methods for each of the target trajectory candidates 1 to n, or the evaluation function may be uniformly adjusted in the same manner.

The target trajectory candidate selection unit 14 selects a trajectory with high feasibility from among the plurality of target trajectory candidates 1 to n generated by the target trajectory candidate generation unit 13. For example, the target trajectory candidate selection unit 14 may select a trajectory that is likely to have the highest feasibility from the viewpoint of the distance (norm) to the constraint condition, the satisfaction level of the constraint condition, and the satisfaction level of the target among the target trajectory candidates 1 to n. For example, the target trajectory candidate selection unit 14 may calculate a robustness index obtained by quantifying the norm to the constraint condition, the satisfaction level of the constraint condition, and the satisfaction level of the target by a predetermined function or the like for each of the target trajectory candidates 1 to n, evaluate the target trajectory candidates 1 to n, and select a candidate having the largest value of the robustness index.

The target trajectory correction unit 15 corrects the trajectory using the target trajectory candidate selected by the target trajectory candidate selection unit 14 as an initial value. For example, the target trajectory correction unit 15 may perform an optimization process using the target trajectory candidate selected by the target trajectory candidate selection unit 14 as an initial value. For example, the target trajectory correction unit 15 may correct the target trajectory candidate selected by path/motion planning using a rapidly-exploring random tree (RRTs) such as an A* algorithm or an RRT* with the target trajectory candidate selected by the target trajectory candidate selection unit 14 as an initial value.

### (Operation)

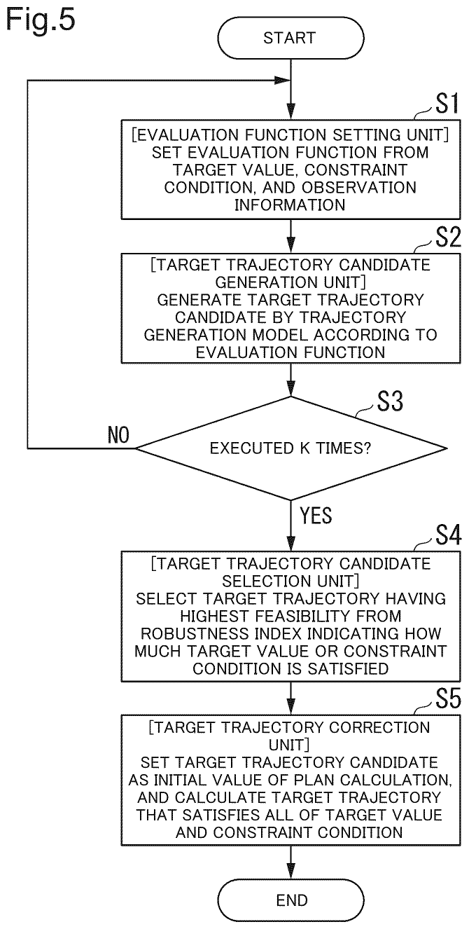

Next, the operation of the control device 10 according to the first example embodiment will be described with reference to FIG. 5.

FIG. 5 is a flowchart illustrating an example of a target trajectory generation process.

The evaluation function setting unit 11 sets an evaluation function of evaluating the trajectory candidate from the target value, the constraint condition, and the observation information (step S1). Next, the target trajectory candidate generation unit 13 generates at least one target trajectory candidate by the trajectory generation model 131 according to the evaluation function (step S2). For example, the target trajectory candidate generation unit 13 may generate n target trajectory candidates 1 to n, or may generate only one target trajectory candidate. The target trajectory candidate generation unit 13 repeatedly performs the process of steps S1 to S2 until calculation of the target trajectory candidate is performed K times (step S3). During execution of steps S1 to S2 K times, the evaluation function of step S1 may be gradually and strictly set, or when there is a strong tendency to collide with an obstacle, a target trajectory candidate may be generated with emphasis on avoiding the obstacle by increasing the weighting related to the obstacle in the evaluation function. When the process of generating the target trajectory candidate is repeated K times using the activation generation model, the target trajectory candidate generation unit 13 outputs the at least one generated target trajectory candidate to the target trajectory candidate selection unit 14.

Next, the target trajectory candidate selection unit 14 calculates a robustness index indicating how much the target value and the constraint condition are satisfied, and selects the target trajectory candidate having the highest feasibility based on the robustness index (step S4). The target trajectory candidate selection unit 14 outputs the selected target trajectory candidate to the target trajectory correction unit 15. Next, the target trajectory correction unit 15 sets the target trajectory candidate as an initial value of plan calculation, and calculates a target trajectory that satisfies all of the target value and the constraint condition (step S5). For example, the target trajectory correction unit 15 corrects the target trajectory candidate selected by the target trajectory candidate selection unit 14 and calculates a final target trajectory that satisfies all of the target value and the constraint condition.

### (Effects)

By using the trajectory generation model 131, a trajectory can be generated at a high speed. However, it is not always possible to obtain a trajectory satisfying the target value and the constraint condition. In the present example embodiment, the target trajectory candidate generated by the trajectory generation model 131 is corrected in such a way as to satisfy all of the target value and the constraint condition. As a result, it is possible to calculate a trajectory having high feasibility at a high speed.

### Second Example Embodiment

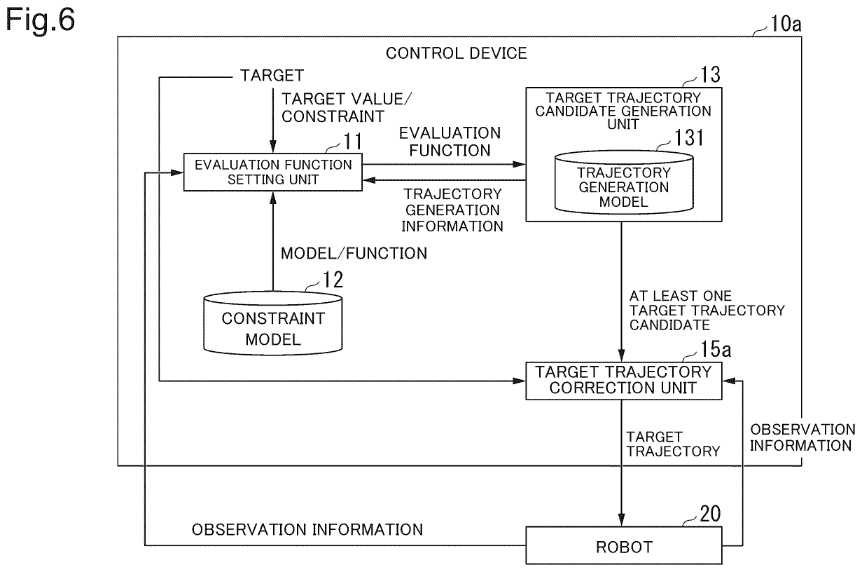

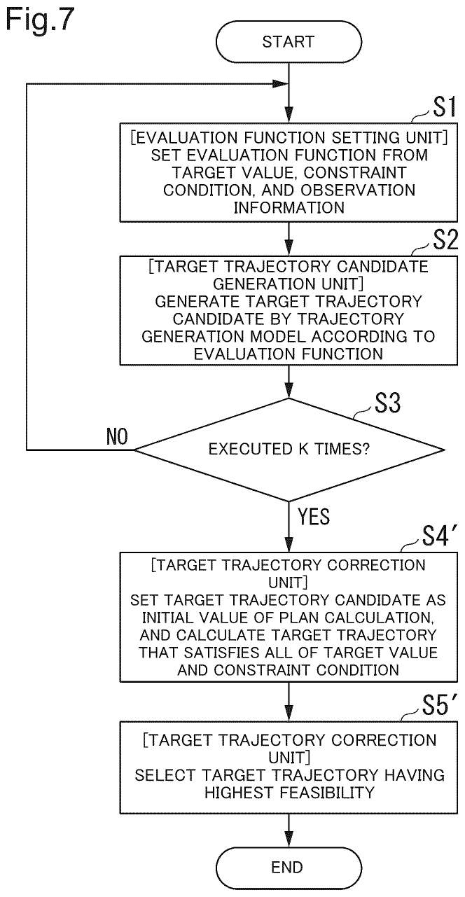

Hereinafter, a control device according to the second example embodiment will be described with reference to FIGS. 6 to 7.

### (Configuration)

A control device 10a includes an evaluation function setting unit 11, a constraint model 12, a target trajectory candidate generation unit 13, and a target trajectory correction unit 15a. The control device 10a according to the second example embodiment does not include the target trajectory candidate selection unit 14 but includes a target trajectory correction unit 15a instead of the target trajectory correction unit 15. Other configurations are similar to those of the first example embodiment.

The target trajectory correction unit 15a acquires at least one target trajectory candidate generated by the target trajectory candidate generation unit 13, performs correction by optimization, path/motion planning, or the like for each candidate, and calculates a target trajectory that satisfies all of the target value and the constraint condition. When the target trajectory candidate generation unit 13 calculates a plurality of target trajectory candidates, a plurality of target trajectories is generated. For example, the plurality of target trajectories may be calculated by performing optimization or correction by path/motion planning or the like in parallel using a plurality of computers. When there is a plurality of target trajectories, the target trajectory correction unit 15a selects a trajectory having the highest feasibility from the plurality of target trajectories as a final target trajectory. For example, the target trajectory correction unit 15a may evaluate the target trajectory candidates 1 to N according to the norm to the constraint condition and select a candidate having the largest value of the norm.

### (Operation)

Next, the operation of the control device 10a of the second example embodiment will be described with reference to FIG. 7.

FIG. 7 is a flowchart illustrating an example of a target trajectory generation process according to the second example embodiment. Processes similar to those in the first example embodiment are denoted by the same reference numerals and will be briefly described.

The evaluation function setting unit 11 sets an evaluation function from the target value, the constraint condition, and the observation information (step S1). Next, the target trajectory candidate generation unit 13 generates at least one target trajectory candidate by the trajectory generation model 131 according to the evaluation function (step S2). The target trajectory candidate generation unit 13 repeatedly performs the process of steps S1 to S2 until calculation of the target trajectory candidate is performed K times (step S3). Next, the target trajectory candidate generation unit 13 outputs the generated at least one target trajectory candidate to the target trajectory correction unit 15a. Next, the target trajectory correction unit 15a sets the target trajectory candidate as an initial value of plan calculation, and calculates a target trajectory that satisfies all of the target value and the constraint condition (step S4′). Next, the target trajectory correction unit 15a selects a target trajectory candidate having the highest feasibility (step S5′).

For example, the target trajectory correction unit 15a may calculate the norm to the constraint condition and select the target trajectory candidate having the largest value of the norm to the constraint condition as the final target trajectory.

### (Effects)

Even in a case where the target trajectory candidate selection unit 14 is not provided, a trajectory having high feasibility can be calculated at a high speed as in the first example embodiment.

### Third Example Embodiment

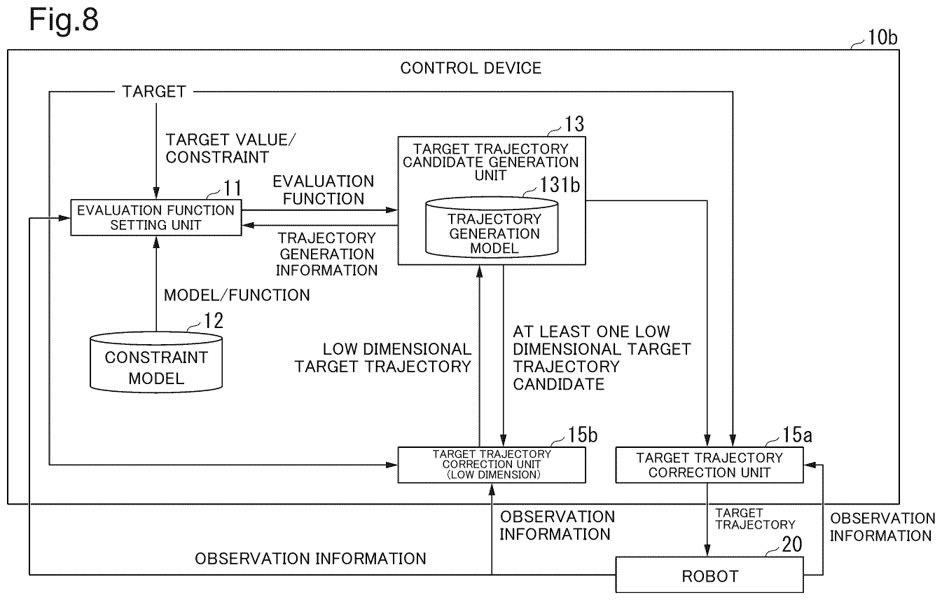

Hereinafter, a control device according to a third example embodiment will be described with reference to FIGS. 8 to 11.

### (Configuration)

A control device 10b includes an evaluation function setting unit 11, a constraint model 12, a target trajectory candidate generation unit 13, a target trajectory correction unit 15a, and a target trajectory correction unit (low dimension) 15b. The control device 10b according to the third example embodiment includes the target trajectory correction unit (low dimension) 15b in addition to the target trajectory correction unit 15a. Other configurations are the same as those of the second example embodiment. In FIG. 8, the configuration example combined with the second example embodiment is described, but the configuration example can also be combined with the first example embodiment.

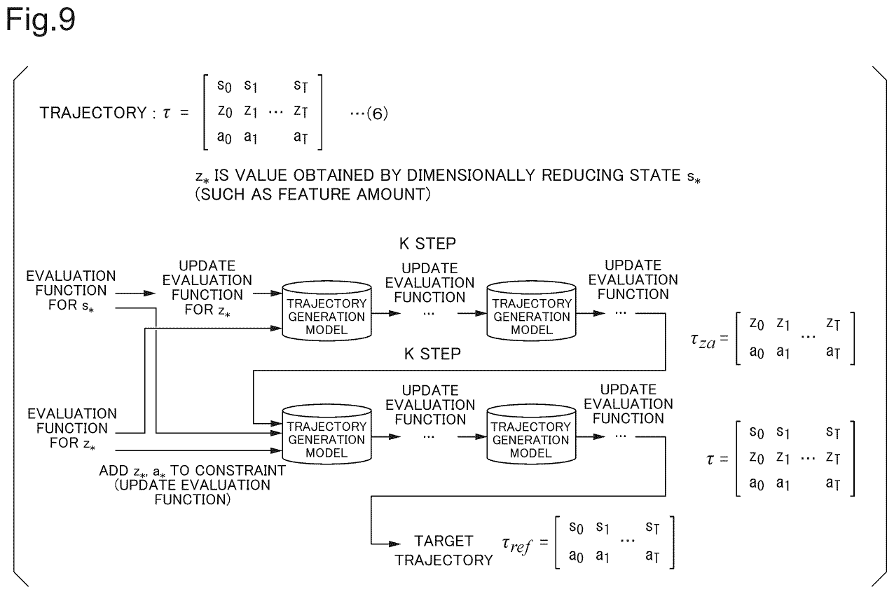

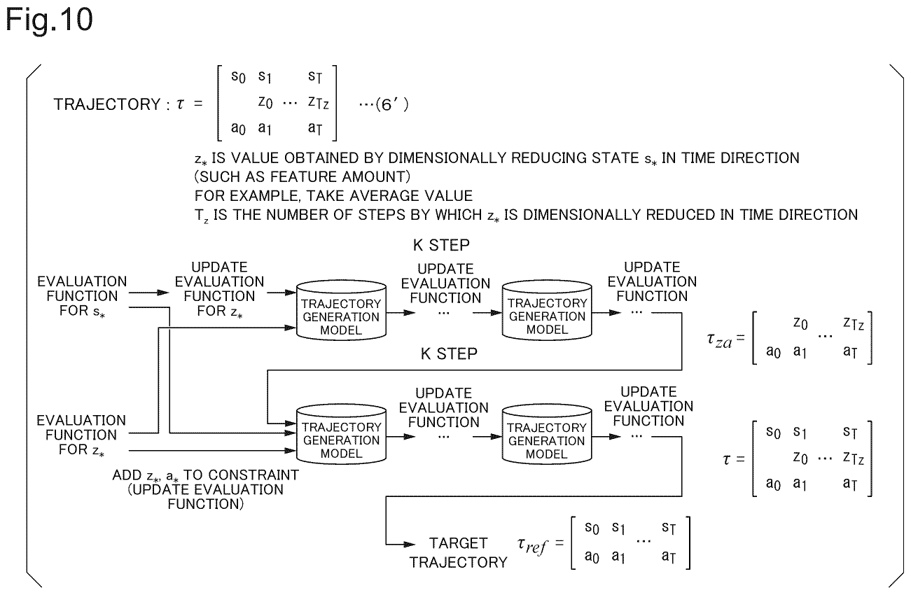

The target trajectory candidate generation unit 13 includes a trajectory generation model 131b. The trajectory generation model 131b is a diffusion model constructed by learning the trajectory τ defined by Expression (6) in FIG. 9 or Expression (6′) in FIG. 10. z is a parameter obtained by reducing the dimension of the state s. In the method of reducing the dimension, the feature amount of the state s may be calculated, or the dimension may be reduced by reducing the data in the time direction. Using the trajectory generation model 131b, the target trajectory candidate generation unit 13 gives an evaluation function (the structure of the evaluation function itself is similar to that of the first example embodiment) calculated for the dimensionally reduced state z as illustrated in FIGS. 9 and 10 for the combination of the action a and z indicating the dimensionally reduced state, and repeats the K-step trajectory generation process to generate at least one low dimensional target trajectory candidate. The target trajectory correction unit (low dimension) 15b corrects the generated low dimensional target trajectory candidate in such a way as to satisfy all of the target value and the constraint condition. When the low dimensional target trajectory satisfying all of the target value and the constraint condition is generated, the target trajectory candidate generation unit 13 sets the low dimensional target trajectory as the initial value using the trajectory generation model 131b, gives the evaluation function (the structure of the evaluation function is similar to that of the first example embodiment) calculated with respect to the state s and the dimensionally reduced state z with respect to the combination of the action a, the state s, and the dimensionally reduced state z, that is, τ defined by Expression (6) or (6′), and repeats the K-step trajectory generation process to generate at least one target trajectory candidate.

Alternatively, the target trajectory candidate generation unit 13 may include a trajectory generation model 131b′ that is a diffusion model constructed by learning a trajectory by a combination of the action a and z indicating a dimensionally reduced state, and the trajectory generation model 131b that is a diffusion model constructed by learning a trajectory τ defined by Expression (6) in FIG. 9 or Expression (6′) in FIG. 10. The target trajectory candidate generation unit 13 repeats the K-step trajectory generation process by the trajectory generation model 131b′ to generate at least one low dimensional target trajectory. The target trajectory correction unit (low dimension) 15b corrects the generated low dimensional target trajectory candidate in such a way as to satisfy all of the target value and the constraint condition. Next, the target trajectory candidate generation unit 13 generates at least one target trajectory that satisfies the target value achieved by the corrected low dimensional target trajectory by repeatedly performing the K-step trajectory generation process using the trajectory generation model 131b. The target trajectory correction unit 15a corrects the generated target trajectory candidate in such a way as to satisfy all of the target value and constraint condition.

### (Operation)

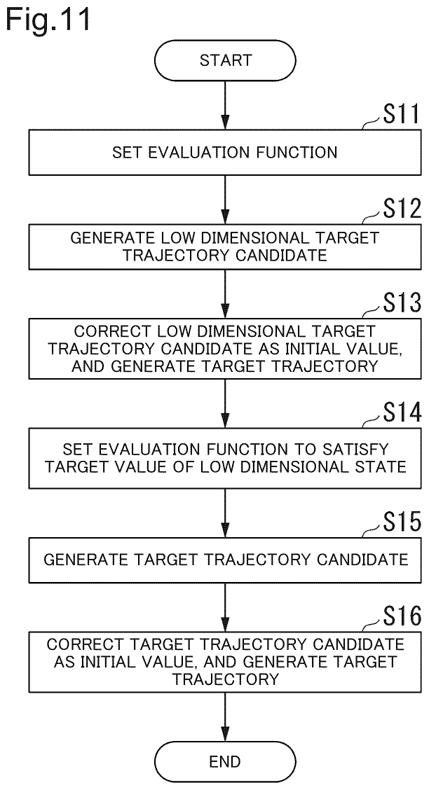

FIG. 11 is a third flowchart illustrating an example of the target trajectory generation process.

The evaluation function setting unit 11 sets a low dimensional evaluation function used for target generation from the target value, the constraint condition, and the observation information (step S11). Next, the target trajectory candidate generation unit 13 performs the generation process of the target trajectory candidate by the trajectory generation model 131b K times to generate at least one low dimensional target trajectory candidate (step S12). Next, the target trajectory correction unit (low dimension) 15b sets a low dimensional target trajectory candidate as an initial value, performs correction in such a way as to satisfy all of the target value and the constraint condition, and calculates a low dimensional target trajectory (step S13). Next, the evaluation function setting unit 11 sets an evaluation function from the target value, the constraint condition, and the observation information. In addition to Expression (1) in FIG. 2, the evaluation function setting unit 11 sets the evaluation function in such a way as to satisfy the target value of the low dimensional state (step S14). Next, the target trajectory candidate generation unit 13 performs the generation process of the target trajectory candidate by the trajectory generation model 131b K times, and generates at least one target trajectory candidate that satisfies the target value achieved by the low dimensional target trajectory calculated in step S13 and maximizes the value of the evaluation function as illustrated in FIG. 2 (step S15). Next, the target trajectory correction unit 15a corrects the target trajectory candidates calculated in step S15 in such a way as to satisfy all of the target value and the constraint condition, and calculates the target trajectory (step S16). Next, the target trajectory correction unit 15a selects a target trajectory having the highest feasibility from the calculated target trajectories.

### (Effects)

When the trajectory is generated for the trajectory τ including the state s from the beginning, for example, complicated calculation is performed in consideration of all conditions such as the speed, the acceleration, the posture, and the like of the robot 20, and a solution (trajectory) may not be calculated. Therefore, the state s is dimensionally reduced, for example, for an arm distal end position of the robot 20, a rough trajectory is generated focusing only on the dimensionally reduced state z and the action a, and then a trajectory is calculated for the state s, thereby calculating a target trajectory in consideration of detailed conditions. As a result, the stability of calculation and the accuracy of the calculated target trajectory can be improved.

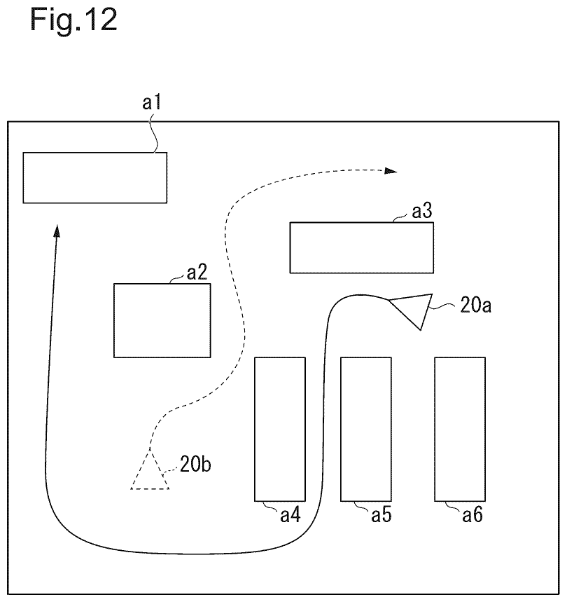

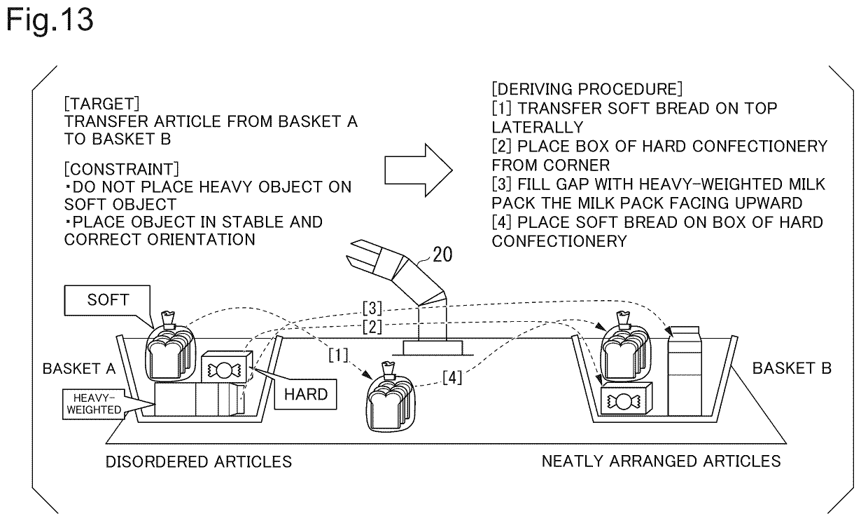

Next, an application example of each of the above example embodiments will be described with reference to FIGS. 12 and 13. FIG. 12 illustrates an example of trajectories of the robots 20a and 20b in a case where an object is picked from any of the shelves a1 to a6 provided indoors and outdoors and the object is moved to another shelf. The trajectory generation method of the present disclosure can be used for calculating a trajectory in such a case. For example, in the learning phase, the position/posture/actuator information (tire rotation angle, rotation speed, etc.) of the robot is collected as the state s, and the data of the type of the control input or the action related to the state s is collected as the action a. For the data collection, demonstration by a person may be used, or data may be prepared by simulation or the like. For the state s, for example, the dimensionally reduced state z may be defined by using only the position and posture information about a representative point on the robot. The target trajectory candidate generation unit 13 learns the collected data and constructs a diffusion model (trajectory generation model 131). Next, the control device 10 generates the trajectory of the robot 20 by the processing referred to in FIGS. 5, 7, 11, and the like. As a result, for example, it is possible to calculate a target trajectory in which the robot 20 can carry the picked object from the shelf a3 to another shelf a1 without hitting the intermediate shelf. In addition, the target trajectory calculation method according to each example embodiment of the present disclosure can be applied to a movement plan and a work plan (excavation and the like) of a construction machine/dump outdoors, a movement plan and a work plan (photographing inside a warehouse, picking and transporting articles in shelves, etc.) of a mobile robot in a warehouse, and a movement plan and a work plan (replenishment of products, arrangement of backyard, and the like) of a mobile robot in retail.

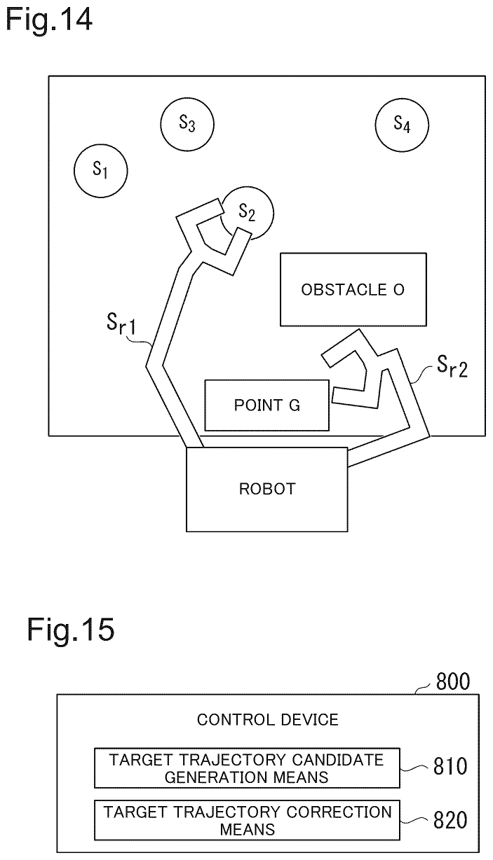

As illustrated in FIG. 13, the target trajectory calculation method according to each example embodiment of the present disclosure can also be applied to the trajectory of the arm of the robot 20 when the article is transferred from the basket A to the basket B. For example, in the learning phase, data of an angle and an angular velocity of each joint of the robot 20 as the state s, a control input (for example, joint angle, angular velocity, torque, and the like) and an action type (Grasp, Move, Realease, etc.) of the robot or the robot hand related to the state as a three dimensional information action of the target object or the obstacle, and a variable (δ or the like) representing the hybrid system are collected. For the data collection, demonstration by a person may be used, or data may be prepared by simulation or the like. For the state s, the dimensionally reduced state z may be defined based on the three dimensional information. The dimensionally reduced state is, for example, information about a two dimensional robot. FIG. 14 illustrates an example of a dimensionally reduced two dimensional model of the robot 20. The target trajectory candidate generation unit 13 learns the collected data and constructs a diffusion model (trajectory generation model 131). Next, the control device 10 generates the trajectory of the robot 20 by the processing referred to in FIGS. 5, 7, 11, and the like. For the evaluation function in step S1, a success/failure discriminator for determining success/failure of the target trajectory to be generated may be reflected, and determination of success may be added as a constraint. A constraint condition that the distance between the data collected as the learning data and the target trajectory to be generated is equal to or less than a certain value may be added to make it difficult to take a state that does not exist in the collected data.

### <Optimization Process>

As described above, the target trajectory correction unit 15 corrects the target trajectory candidate generated by the trajectory generation model 131 by optimization or the like. A flow of processing for optimizing the target trajectory candidate will be described. The following processes are executed by the target trajectory correction unit 15.

(STEP1) Set abstract state from measurement information.

In FIG. 14, ∘ represents an object, sᵢ represents a state of the object i and sᵣᵢ represents a state of the robot hand i. For example, it is assumed that a desirable state is “the object 2 is at the point G”. In STEP1, an abstract state in the work space of the robot is expressed by a logical proposition. For example, that the object i is at the point G is represented by gᵢ, that the object i is interfering with the obstacle O is represented by Oᵢ, that the robot hands interfere with each other is represented by h, and, in a case where the object i is at the point G, gᵢ=1.

(STEP2) A final achievement state is calculated from the task instruction and the application information. In STEP2, after the task is expressed by a logical proposition, a physical constraint and a common sense constraint necessary for the operation of the robot are added as a logical proposition. For example, it is assumed that a target task that “the object 2 finally exists at the point G” is given. In this case, the logical formula “□g₂” is generated using the operator “□” corresponding to “eventually” of the linear logical formula (Linear Temporal Logic (LTL)) and the proposition “gᵢ” of the abstract state set in STEP1 as the target task. A final target setting unit 16 may express the logical formula using any time-phase logic operator (logical product “□”, logical sum “□”, negative “¬”, logical inclusion “⇒”, always “□”, next “∘”, until “U”, and the like) other than the operator “□”. The logical formula may be expressed not only using the linear time-phase logic, but also using any time-phase logic such as a Metric Temporal Logic (MTL) or a Signal Temporal Logic (STL). Next, for example, in a case where two constraint conditions that “the robots do not interfere with each other” and “the object i does not interfere with the obstacle O” are given as constraint conditions related to pick and place, these constraint conditions are converted into the following logical formulas.
“The robots do not interfere with each other” □¬h
“The object i does not interfere with the obstacle O” □ᵢ□¬oᵢ

Therefore, in this case, the logical formula related to the target task that “the object 2 finally exists at the point G” is as follows.

(□g₂)□(□¬h)∧(∧ᵢ□¬oᵢ)

(STEP3) Calculate all logical propositions at each time step that can achieve the final goal.

In STEP3, candidates of logical propositions to be satisfied in each time step are listed for the final target. For example, a specific example in a case where a target task that “the object 2 finally exists at the point G” is set will be described. Hereinafter, the proposition “g_{i,k}” obtained by extending the proposition “gᵢ” in such a way as to include a concept of a time step is used. The proposition “g_{i,k}” is a proposition that “the object i exists at the point G in the time step k”. In a case where the target number of time steps is “3”, the proposition that the object 2 is at the point G after three steps can be described by the following Expression.

⋄g_{2,3}(¬g_{2,1}∧¬g_{2,2}∧g_{2,3})∨(¬g_{2,1}∧g_{2,2}∧g_{2,3})∨(g_{2,1}∧¬9_{2,2}∧g_{2,3})∨(g_{2,1}∧g_{2,2}∧g_{2,3}) [Math. 1]

At this time, the final target logical formula Ltag is represented by a logical sum (φ₁□φ₂□φ₃□β₄) of the following four candidates “φ₁” to “φ₄”.

φ₁=(¬g_{2,1}∧¬g_{2,2}∧g_{2,3})∧(∧_{k=1,2,3}□¬hₖ)∧(∧_{i,k=1,2,3}□¬o_{i,k})

φ₂=(¬g_{2,1}∧g_{2,2}∧g_{2,3})∧(∧_{k=1,2,3}□¬hₖ)∧(∧_{i,k=1,2,3}□¬o_{i,k})

φ₃=(g_{2,1}∧¬g_{2,2}∧g_{2,3})∧(∧_{k=1,2,3}□¬hₖ)∧(∧_{i,k=1,2,3}□¬o_{i,k})

φ₄=(g_{2,1}∧g_{2,2}∧g_{2,3})∧(∧_{k=1,2,3}□¬hₖ)∧(∧_{i,k=1,2,3}□¬o_{i,k}) [Math. 2]

(STEP4) Creates an abstraction model from application information, measurement information, and subtask information. In STEP4, expression is made by an abstraction model that simulates actual dynamics in such a way that evaluation can be performed in the subsequent optimization calculation (STEP5).

At the time of the work of the target task by the robot 20, dynamics in the work space is frequently switched. For example, in pick and place, in a case where the robot arm grasps the target object i, the target object i can be moved, but in a case where the robot arm does not grasp the target object i, the target object i cannot be moved. When the operation of grasping the object i is abstractly expressed by the logical variable “S1”, the abstraction model to be set for the work space can be described by the following Expression.

$$\begin{matrix}[ Math . 3 ] & \\ {[ \begin{matrix}{S}_{r 1} \\ {S}_{r 2} \\ {S}_{1} \\ ⋮ \\ {S}_{4}\end{matrix} ]}_{k + 1} = {I [ \begin{matrix}{S}_{r 1} \\ {S}_{r 2} \\ {S}_{1} \\ ⋮ \\ {S}_{4}\end{matrix} ]}_{k} + [ \begin{matrix}I & 0 \\ 0 & I \\ {δ}_{1 , 1} I & {δ}_{2 , 1} I \\ ⋮ & ⋮ \\ {δ}_{1 , 4} I & {δ}_{2 , 4} I\end{matrix} ] [ \begin{matrix}{a}_{1} \\ {a}_{2}\end{matrix} ] & ( 7 )\end{matrix}$$

$${h}_{{ij}_{min}} ( 1 - {δ}_{i} ) \leq {h}_{ij} ( x ) \leq {h}_{{ij}_{max}} {δ}_{i} + ( {δ}_{i} - 1 ) ε$$

“aⱼ” represents a control input for controlling the robot hand j.

“I” indicates an identity matrix. “0” indicates a zero row example. The control input is assumed to be speed as an example, but may be acceleration. “δ_{j,i}” is a logical variable that is “1” in a case where the robot hand j grasps the object i, and is “0” in other cases. “sᵣ₁” and “sᵣ₂” indicate the position vector of the robot hand j, and “s₁” to “s₄” indicate the position vector of the object i. “h(s)” is a variable that satisfies “h(s)≥0” in a case where the robot hand exists in the vicinity of the object to such an extent that the object can be grasped, and satisfies the following relationship with the logical variable &.

δ=1□h(s)≥0

In this Expression, in a case where the robot hand exists in the vicinity of the object to such an extent that the object can be grasped, it is assumed that the robot hand grasps the object, and the logical variable b is set to 1. The above Expression (7) is a difference equation indicating the relationship between the state of the object in the time step k and the state of the object in the time step (k+1). In the above Expression (7), since the state of grasping is represented by a logical variable of a discrete value and the movement of the object is represented by a continuous value, Expression (7) represents a hybrid system. In Expression (7), not the detailed dynamics of the entire robot 20 but only the dynamics of the robot hand that is the hand of the robot 20 that actually grasps the target object is considered. As a result, the calculation amount of the next-step optimization calculation can be suitably reduced. Instead of the model shown in Expression (7), a model of a Mixed Logical Dynamical (MLD) system or a hybrid system in which a Petri net, an automaton, and the like are combined may be generated.

(STEP5) Calculate a control result that optimizes the evaluation function based on the abstraction model.

By optimization calculation using an abstract model, a control input that satisfies a logical proposition to be satisfied in each time step and optimizes an evaluation function is obtained. For example, in a case where pick and place is a target task, an evaluation function is determined in such a way that a distance “dₖ” between a target object to be carried and a target point to which the target object is carried and a control input “aₖ” are minimized (that is, energy consumed by the robot 20 is minimized). The distance dₖ described above corresponds to the distance between the object 2 and the point G in the time step k in the case of the target task that “the object 2 finally exists at the point G”.

For example, the sum of the square of the norm of the distance dₖ and the square of the norm of the control input uₖ in all time steps is determined as the evaluation function. The constrained mixed integer optimization problem shown in the following Expression (8) is solved. At this time, the target trajectory correction unit 15 searches for a trajectory that satisfies Expression (8) with the target trajectory candidate generated by the target trajectory candidate generation unit 13 or the target trajectory candidate selected by the target trajectory candidate selection unit 14 as an initial value.

$$\begin{matrix}[ Math . 4 ] & \\ {min}_{a} ( {\sum }_{k = 0}^{T} ( {‖ {d}_{k} ‖}_{2}^{2} + {‖ {a}_{k} ‖}_{2}^{2} ) ) & ( 8 )\end{matrix}$$

$$s . t . \sum$$

$$⋁ {∅}_{i}$$

where “T” is the number of time steps to be optimized, may be the target number of time steps, or may be a predetermined number smaller than the target number of time steps as described later. In this case, preferably, a control input generation unit 35 approximates the logical variable to a continuous value (set as a continuous relaxation problem). As a result, the control input generation unit 35 can suitably reduce the calculation amount. In a case where STL is used instead of the linear logical formula (LTL), the problem can be described as a nonlinear optimization problem.

When the target number of time steps is long (for example, larger than a predetermined threshold value), the number of time steps T in Expression (8) used for optimization may be set to a value smaller than the target number of time steps (for example, the above-described threshold value). In this case, for example, every time a predetermined number of time steps elapses, the control input aₖ is sequentially determined by solving the optimization problem based on Expression (8).

FIG. 15 is a block diagram illustrating a configuration of a control device having a minimum configuration.

The control device 800 includes a target trajectory candidate generation means 810 and a target trajectory correction means 820.

The target trajectory candidate generation means 810 generates at least one target trajectory candidate using a trajectory generation model that generates a target trajectory.

The target trajectory correction means 820 corrects the target trajectory candidate to generate a target trajectory that satisfies the constraint condition.

The target trajectory candidate generation means 810 can be implemented by using, for example, a function of the target trajectory candidate generation unit 13. The target trajectory correction means 820 can be implemented using a function of at least any of the target trajectory correction unit 15, the target trajectory correction unit 15a, and the target trajectory correction unit (low dimension) 15b.

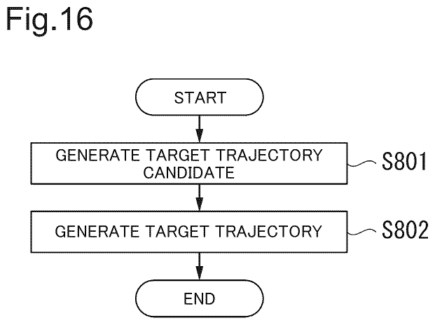

FIG. 16 is a flowchart of a trajectory generation method having a minimum configuration.

The target trajectory candidate generation means 810 generates at least one target trajectory candidate using a trajectory generation model that generates a target trajectory (step S810). Next, the target trajectory correction means 820 corrects the target trajectory candidate to generate the target trajectory satisfying the constraint condition (step S820).

Part of the control device 10 in the above-described example embodiment may be implemented by a computer. In this case, a program for implementing this function may be recorded in a computer-readable recording medium, and the program recorded in the recording medium may be read and executed by a computer system to implement the program. The “computer system” mentioned herein is a computer system built in the control device 10, and includes hardware such as an operating system (OS) and peripheral devices.

The “computer-readable recording medium” refers to a portable medium such as a flexible disk, a magneto-optical disk, a ROM, or a CD-ROM, and a storage device such as a hard disk built in the computer system. Furthermore, the “computer-readable recording medium” may include a medium that dynamically holds a program for a short time, such as a communication line in a case where the program is transmitted via a network such as the Internet or a communication line such as a telephone line, and a medium that holds a program for a certain period of time, such as a volatile memory inside a computer system serving as a server or a client in this case. The program may be for implementing some of the functions described above, and the functions described above may be implemented in combination with a program already recorded in the computer system.

Part or all of the control device 10 in the above-described example embodiment may be implemented as an integrated circuit such as a large scale integration (LSI). Each functional unit of the control device 10 may be individually formed into a processor, or some or all of the functional units may be integrated into a processor. The circuit integration method may be implemented not only by the LSI, but also by a dedicated circuit or a general-purpose processor. In a case where an integrated circuit technology replacing the LSI has emerged due to the progress of the semiconductor technology, an integrated circuit according to the technology may be used.

As described above, some example embodiments according to the present disclosure have been described, but all these example embodiments are presented as examples, and are not intended to limit the scope of the invention. These example embodiments can be implemented in various other forms, and various omissions, substitutions, and changes can be made without departing from the gist of the invention. These example embodiments and modifications thereof are included in the scope and gist of the invention, and are included in the invention described in the claims and the equivalent scope thereof.

### <Supplementary Note>

The control device, the trajectory generation method, and the recording medium described in the example embodiment are grasped as follows, for example.

(1) A control device according to a first aspect includes a target trajectory candidate generation means for generating at least one target trajectory candidate using a trajectory generation model that generates a target trajectory, and a target trajectory correction means for correcting the target trajectory candidate and generating a target trajectory satisfying a constraint condition.

(2) A control device according to a second aspect is the control device according to (1), wherein the trajectory generation model is a diffusion model, and the target trajectory candidate generation means generates the target trajectory candidate through a plurality of times of generation processes using the trajectory generation model.

(3) A control device according to a third aspect is the control device according to any one of (1) to (2), wherein the target trajectory candidate generation means generates the target trajectory candidate through the plurality of times of generation processes in such a way that a value of an evaluation function of evaluating how much a target value of the target trajectory candidate is achieved, how much the target trajectory candidate satisfies a constraint condition, and how much the target trajectory candidate avoids collision with an obstacle is improved.

(4) A control device according to a fourth aspect is the control device according to any one of (1) to (3), wherein the target trajectory candidate generation means changes the evaluation function in such a way that the constraint condition at a (k+1)-th time is stricter than the constraint condition at a k-th time in the plurality of times of generation processes.

(5) A control device according to a fifth aspect is the control device according to any one of (1) to (4), wherein the target trajectory candidate generation means sets a large weight for at least one of an evaluation of how much the target value is achieved in the evaluation function at a (k+1)-th time rather than at a k-th time in the generation process of the plurality of times, an evaluation of how much the constraint condition is satisfied, and an evaluation of how much the collision with the obstacle is avoided.

(6) A control device according to a sixth aspect is the control device according to any one of (1) to (5), the control device further includes a target trajectory candidate selection means for selecting a target trajectory candidate having the highest feasibility from the at least one or more generated target trajectory candidates.

(7) A control device according to a seventh aspect is the control device according to any one of (1) to (6), wherein the target trajectory candidate generation means generates at least one low dimensional target trajectory candidate using a low dimensional trajectory generation model constructed by data obtained by dimensionally reducing training data used for constructing the trajectory generation model, and generates the at least one target trajectory candidate that satisfies a target value achieved by the low dimensional target trajectory candidate using the trajectory generation model.

(8) A control device according to an eighth aspect is the control device according to (1) to (7), wherein the target trajectory correction means sets the target trajectory candidate as an initial value, and performs an optimization process to generate the target trajectory.

(9) A trajectory generation method according to a ninth aspect executed by a computer, includes generating at least one target trajectory candidate by using a trajectory generation model that generates a target trajectory, and correcting the target trajectory candidate to calculate a target trajectory satisfying a constraint condition.

(10) A recording medium according to a tenth aspect is a recording medium storing a program for causing a computer to execute a step of generating at least one target trajectory candidate by using a trajectory generation model that generates a target trajectory, and a step of correcting the target trajectory candidate to calculate a target trajectory satisfying a constraint condition.

### INDUSTRIAL APPLICABILITY

According to the control device, the trajectory generation method, and the recording medium described above, it is possible to calculate a trajectory having high feasibility.

### REFERENCE SIGNS LIST

10, 10a, 10b control device
11 evaluation function setting unit
12 constraint model
13 target trajectory candidate generation unit
131 trajectory generation model
14 target trajectory candidate selection unit
15, 15a target trajectory correction unit
15b target trajectory correction unit (low dimension) robot

1. A control device comprising:
a memory storing instructions; and
a processor connected to the memory and configured to execute the instructions to:
generate at least one target trajectory candidate using a trajectory generation model that generates a target trajectory; and
correct the target trajectory candidate; and
generate a target trajectory satisfying a constraint condition.

2. The control device according to claim 1, wherein
the trajectory generation model is a diffusion model, and
the processor is configured to execute the instructions to
generate the target trajectory candidate through a plurality of times of generation processes using the trajectory generation model.

3. The control device according to claim 2, wherein
the processor is configured to execute the instructions to generate the target trajectory candidate through the plurality of times of generation processes in such a way that a value of an evaluation function of evaluating how much a target value of the target trajectory candidate is achieved, how much the target trajectory candidate satisfies a constraint condition, and how much the target trajectory candidate avoids collision with an obstacle is improved.

4. The control device according to claim 3, wherein
the target trajectory candidate generation means the processor is configured to execute the instructions to
change the evaluation function in such a way that the constraint condition at a (k+1)-th time is stricter than the constraint condition at a k-th time in the plurality of times of generation processes.

5. The control device according to claim 3, wherein
the processor is configured to execute the instructions to
set a large weight for at least one of an evaluation of how much the target value is achieved in the evaluation function at a (k+1)-th time rather than at a k-th time in the generation process of the plurality of times, an evaluation of how much the constraint condition is satisfied, and an evaluation of how much the collision with the obstacle is avoided.

6. The control device according to claim 1, wherein
the processor is configured to execute the instructions to
select a target trajectory candidate having the highest feasibility from the at least one or more generated target trajectory candidates.

7. The control device according to claim 1, wherein
the processor is configured to execute the instructions to
generate at least one low dimensional target trajectory candidate using a low dimensional trajectory generation model constructed by data obtained by dimensionally reducing training data used for constructing the trajectory generation model, and
generate the at least one target trajectory candidate that satisfies a target value achieved by the low dimensional target trajectory candidate using a trajectory generation model that generates a target trajectory.

8. The control device according to claim 1, wherein
the processor is configured to execute the instructions to
generate the target trajectory by performing optimization using the target trajectory candidate as an initial value.

9. A trajectory generation method executed by a computer, the method comprising:
generating at least one target trajectory candidate by using a trajectory generation model that generates a target trajectory; and
correcting the target trajectory candidate to calculate a target trajectory satisfying a constraint condition.

10. A recording medium storing a program for causing a computer to execute:
a step of generating at least one target trajectory candidate by using a trajectory generation model that generates a target trajectory; and
a step of correcting the target trajectory candidate to calculate a target trajectory satisfying a constraint condition.
